(19) United States
(12) Patent Application Publication
(10) Pub. No.: US 2009/0208173 A1
(43) Pub. Date: Aug. 20, 2009

(54) FIBER CABLE TERMINATOR

(76) Inventors: John L. Schumann, Litchfield, MN (US); Alan D. Maki, Chaska, MN (US); Bryan J. Scheele, Hutchinson, MN (US); Robert A. Johnson, Litchfield, MN (US)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(21) Appl. No.: 12/034,076

(22) Filed: Feb. 20, 2008

(51) Int. Cl. G02B 6/36

(52) U.S. Cl. 385/77

(57) ABSTRACT

A fiber cable assembly includes a cable formed from a bundle of fiber optic strands, a buffer encasing the bundle, and a terminator clamp coupled to an end of the cable over the buffer. The terminator clamp includes a first clamp portion and a second clamp portion. The first and second clamp portions each have an engaging surface for engaging the other of the first clamp portion and the second clamp portion. A channel is formed between the first clamp portion and the second clamp portion for receiving an end of the cable. The channel has a cross-sectional area that is less than a cross-sectional area of the cable. The end of the cable can be inserted into the first clamp portion and the second clamp portion can be secured to the first clamp portion to secure the clamp terminator to the cable. The cable is compressed within the channel to a reduced cross-sectional area.

### FIELD OF THE INVENTION

The present invention relates to terminators for a fiber cable.

### BACKGROUND

Fiber cables, including fiber optic cables, are employed in a variety of applications for the propagation and transmission of optical signals. Such cables are formed from a bundle of individual fiber optic strands encased in a sheath. Each strand is capable of transmitting all or a portion of an optical signal. Fibers which support many propagation paths or transverse modes are called multimode fibers. Fibers which support only a single mode are called singlemode fibers. Multimode fibers generally are used for short-distance communication links or for applications where high power must be transmitted. Singlemode fibers are used for most communication links longer than 200 meters.

One of the benefits of employing fiber optic cables is that each strand is capable of transmitting optical signals around curves. Fiber optic cables can be used to transmit optical signals along complex, curvilinear routes. Therefore, it is important that a fiber optic cable be sufficiently flexible to tolerate being bent into curved shapes without strand breakage. In addition, however, it is sometime preferable that the end of the fiber optic cable be tightly packed or bound. This can facilitate manipulating the shape of the end face of the fiber optic cable, improve wicking of epoxy into the end of the fiber optic cable and improve the optical polishing characteristics of the end face.

### SUMMARY

In one embodiment, the invention provides a fiber cable assembly including a cable formed from a bundle of fiber optic strands, a buffer encasing the bundle, the cable having a first, uncompressed cross-sectional area, and a terminator clamp coupled to an end of the cable over the buffer. The terminator clamp includes a first clamp portion and a second clamp portion. The first and second clamp portions each have an engaging surface for engaging the other of the first clamp portion and the second clamp portion. The terminator clamp also includes aligned recesses extending inwardly from the engaging surface of the first clamp portion and the second clamp portion. The aligned recesses form a channel within the terminator clamp for receiving the end of the cable. The channel has a cross-sectional area that is less than the cable first cross-sectional area. The cable is compressed within the channel to a second, compressed cross-sectional area that is less than the first cross-sectional area.

In another embodiment, the invention provides a terminator clamp for coupling to an end of a fiber cable. The terminator clamp can include a first clamp portion and a second clamp portion, the first and second clamp portions each having an engaging surface for engaging the other of the first clamp portion and the second clamp portion. The terminator also includes a channel formed between the first clamp portion and the second clamp portion. The channel has a cross-sectional area that is less than the cross-sectional area of the fiber cable.

In another embodiment, the invention provides a method of manufacturing a fiber cable of the type including a plurality of loosely bundled fiber optic strands encased in a buffer. The method includes placing a portion of an end of the fiber cable into a recess in an engaging surface of a first clamp portion, the fiber cable having a first cross-sectional area in a plane perpendicular to a longitudinal axis of the fiber cable. A second clamp portion is aligned with the first clamp portion, the second clamp portion having a cooperating recess in an engaging surface for receiving a portion of the fiber cable. The engaging surface of the first clamp portion is contacted with the engaging surface of the second clamp portion to form a channel between the aligned recesses, the channel having a channel cross-sectional area that is less than the fiber cable cross-sectional area. The fiber cable is compressed within the channel to a second cross-sectional area that is less than the first cross-sectional area.

Other aspects of the invention will become apparent by consideration of the detailed description and accompanying drawings.

### BRIEF DESCRIPTION OF THE DRAWINGS

FIG. 1A schematically illustrates a side view of a fiber cable according to an embodiment of the invention.

FIG. 1B schematically illustrates a top view of the fiber cable of FIG. 1A.

FIG. 2 illustrates a bottom view the clamp terminator of FIG. 1.

FIG. 3 is a perspective view of the first clamp portion of FIG. 2.

FIG. 4 is a bottom view of a first clamp portion in relation to a fiber cable.

FIG. 5 is a bottom view of partially assembled first clamp portion and fiber cable of FIG. 4 in relation to a second clamp portion.

FIG. 6A is a bottom view of the first and second clamp portions of FIG. 5 assembled with the fiber cable.

FIG. 6B shows the first and second clamp portions of FIG. 5 provided with a buffer relief feature.

FIG. 7 is a bottom view of the clamp terminator and fiber cable of FIG. 6 including a bonding agent.

FIG. 8 is a side view of a fiber cable according to another embodiment of the invention.

FIG. 9A is an end perspective view of the fiber cable of FIG. 8.

FIG. 9B shows the fiber cable of FIG. 9A further including a buffer relief feature.

FIG. 10 is a partially sectioned view of the fiber cable of FIG. 9A.

FIG. 11 is a partially sectioned alternate view of the fiber cable of FIG. 9A.

FIG. 12A is an end perspective view of a clamp terminator according to another embodiment of the invention.

FIG. 12B is an exploded view of the clamp terminator of FIG. 12A.

FIG. 13A is an end perspective view of a clamp terminator according to another embodiment of the invention.

FIG. 13B is an exploded view of the clamp terminator of FIG. 13A.

FIG. 14 is a perspective view of a clamp terminator according to another embodiment of the invention.

FIG. 15 is an exploded view of the clamp terminator of FIG. 14.

FIG. 16 is a perspective view of a clamp terminator according to another embodiment of the invention.

FIG. 17 is an exploded view of the clamp terminator of FIG. 16.

FIG. 18A is a perspective view of a clamp terminator in relation to a fiber cable according to another embodiment of the invention.

FIG. 18B is a perspective view of the clamp terminator of FIG. 18A in relation to a pair of fiber cables according to another embodiment of the invention.

FIG. 18C is a perspective view of the clamp terminator of FIG. 18A in relation to a pair of fiber cables according to another embodiment of the invention.

FIG. 19 is a perspective view of a clamp terminator in relation to a fiber cable according to another embodiment of the invention.

FIG. 20 is an exploded view of a clamp terminator according to another embodiment of the invention.

FIG. 21 is a perspective view of the clamp terminator of FIG. 20.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

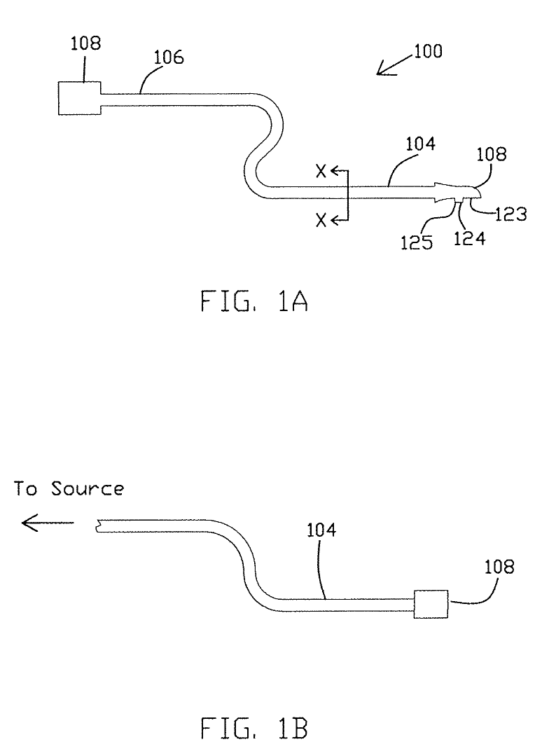

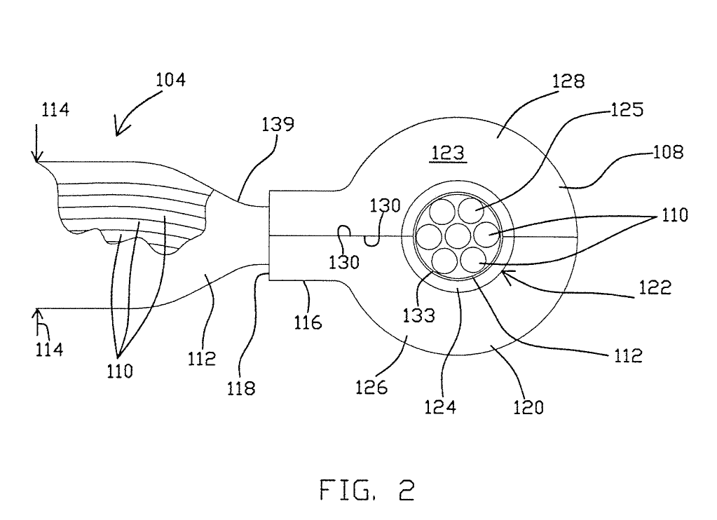

FIGS. 1A and 1B illustrate a fiber cable 100 according to an embodiment of the invention. The fiber cable 100 has a first end 104 and a second end 106, and a clamp terminator 108 coupled to each of the first end 104 and the second end 106. Referring now to FIG. 2, the fiber cable 100 is formed of a bundle of loosely arranged fiber optic strands 110, each capable of transmitting optical signals the length of the cable 100. The fiber cable 100 can be a multimode cable capable of propagating multiple optical signals along its length.

A flexible protective buffer or sheath 112 loosely encases the bundle of strands 110. Because the buffer 112 is loose fitting over the strands 110, the fiber cable 100 is flexible and can be bent without strand breakage. The buffer 112 further inhibits strand breakage and can also reduce crosstalk or signal contamination during use. The buffer 112 has an uncompressed outer diameter as indicated at 114.

The cable 100 has a cross-sectional area in a plane perpendicular to a longitudinal axis of the cable 100, indicated at X-X. By cross-sectional area, it is meant all of the area encompassed by the cable 100 in the plane. In other words, the cross-sectional area of the cable 100 is not limited to the area of the annular face of the buffer 112 in the plane nor to the summed area of the individual strands 110 in the plane.

FIG. 2 illustrates the clamp terminator 108 at the first end 104 of the fiber cable 100. The clamp terminator 108 holds the buffer 112 and the individual strands 110 in a fixed, closely spaced relationship to one another. The clamp terminator 108 can be received in or coupled to a fixture such as a mating or coupling component, a sensor, etc. (not shown) for providing or receiving optical signals transmitted through the fiber cable 100. The clamp terminator 108 can also be provided on a fiber cable 100 used as an optical sensor for measuring an optical signal. The outer size and outer geometry of the clamp terminator 108 can vary depending upon the characteristics of the fixture the clamp terminator 108 is intended to be coupled to.

The clamp terminator 108 includes a neck 116 provided with an inlet 118 and a head 120 provided with an outlet 122. The neck 116 and head 120 can be integrally formed with one another or can be coupled to one another. The outlet 122 is approximately perpendicular to the inlet 118. In the illustrated embodiment, a flange 124 surrounds the outlet 122 such that the outlet 122 protrudes below a surface 123 of the head 120. An end surface 125 of the fiber cable 100 is approximately flush with the flange 124 at the outlet 122. The end surface 125 may be filled with an optical grade epoxy or other bonding agent and polished to promote uniform optical signal flow through.

The clamp terminator 108 includes a first clamp portion 126 and a second clamp portion 128 coupled to one another. In the illustrated embodiment, the first clamp portion 126 and the second clamp portion 128 are mirror images of one another. In other embodiments, the first clamp portion 126 and the second clamp portion 128 may also have the same configuration so that they are interchangeable. In other embodiments, however, the first and second clamp portions 126, 128 may have different configurations from one another so that they are not necessarily interchangeable, but do cooperate with one another.

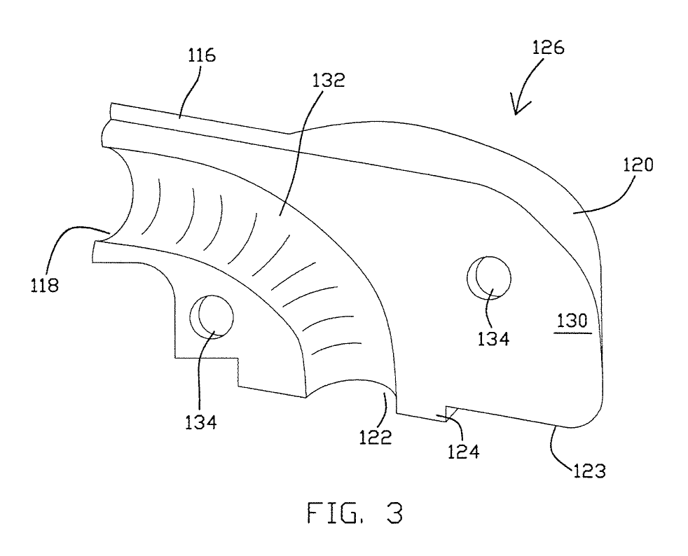

FIG. 3 illustrates the first clamp portion 126. As the second clamp portion 128 is structurally a mirror image of the first clamp portion 126, a description of the features of the first clamp portion 126 will suffice as a description of the features of the second clamp portion 128. The first clamp portion 126 has an inner engaging surface 130. The engaging surface 130 of the first clamp portion 126 faces the corresponding engaging surface of the second clamp portion 128. The engaging surfaces 130 are clamped against the engaging surface of the second clamp portion 128 when the clamp terminator 108 is assembled (see FIG. 2).

Various recesses and/or bores extend inwardly from the engaging surface 130. When the first clamp portion 126 is assembled with the second clamp portion 128, the recesses of the first clamp portion 126 are opposite to and aligned with the recesses of the second clamp portion 128 to form voids within the clamp terminator 108. In the embodiment illustrated in FIG. 3, the first clamp portion 126 includes an elongated recess 132 extending from the inlet 118 to the outlet 122. The recess 132 has a semi-circular cross sectional shape. When the clamp terminator 108 is assembled, the opposing recesses 132 form a channel 133 within the clamp terminator 108 having a circular cross sectional shape (see FIG. 2).

As shown in FIG. 2, the channel 133 formed by the opposing recesses 132 receives the fiber cable 100. In the illustrated embodiment, each recess 132 has a 90 degree are from the clamp terminator inlet 118 to the clamp terminator outlet 122. In other embodiments, each recess 132 may have an arc ranging from about 0 degrees (i.e., straight or non-curvilinear) to about 180 degrees (i.e., U-shaped).

In some embodiments, the clamp terminator 108 includes an aligning feature to facilitate aligning and assemblies the first and second clamp portions 126, 128 with one another (not shown). Either or both of the first clamp portion 126 and the second clamp portion 128 may include protrusions on the inner engaging surface 130 and cooperating recesses for receiving the protrusions to thereby align the first clamp portion 126 with the second clamp portion 128.

The first clamp portion 126 includes one or more threaded coupling apertures 134. When the clamp terminator 108 is assembled, the opposing coupling apertures 134 form a bore through the head 120. Fasteners, such as screws or bolts, are received in the aligned coupling apertures 134 for coupling the first clamp portion 126 to the second clamp portion 128.

In other embodiments, the first clamp portion 126 and the second clamp portion 128 can be snap-fit to one another. Such an arrangement could include a full or partial bore in one of the first clamp portion 126 and the second clamp portion 128 and a ramped stud in the other of the first clamp portion 126 and the second clamp portion 128. In still other embodiments, one of the first clamp portion 126 and the second clamp portion 128 are slid relative to one another to join the clamp portions 126, 128. For example, the first clamp portion 126 can include tongue on the engaging surface 130 and the second clamp portion 128 can include a groove across the engaging surface 130 for receiving the tongue in sliding engagement.

In still another embodiment, an adhesive is applied to one or both of the engaging surfaces 130 to bond the first and second clamp portions 126, 128 together. An adhesive may be the sole means of coupling the first and second clamp portions 126, 128 to one another, or may be employed in conjunction with a mechanical fastener. These are but a few examples of suitable arrangements for coupling the first and second clamp portions 126, 128 that are encompassed by the invention. Although not described in exhaustive detail, one of skill in the art will appreciate that a variety of coupling mechanisms suitable for coupling the first clamp portion 126 to the second clamp portion 128 are encompassed by the invention.

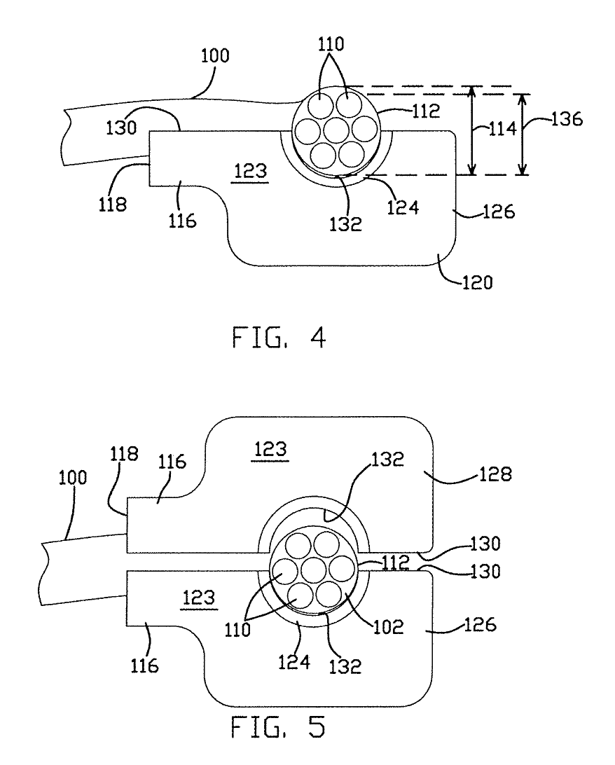

To assemble the clamp terminator 108 with the fiber cable 100, the first end 104 of the cable 100 is positioned in the semi-circular recess 132 of the first clamp portion 126, as shown in FIG. 4. The buffer 112 remains on the first end 104 of the cable 100. Referring now to FIG. 5, the second clamp portion 128 is aligned with the first clamp portion 126. The fasteners (not shown) are each inserted into the aligned coupling apertures 134 of the first and second clamp portions 126, 128 to bring the engaging surface 130 of the first clamp portion 126 into contact with the engaging surface 130 of the second clamp portion 128. Alternately, the second clamp portion 128 is pressed against the first clamp portion 126 and then the fasteners are employed to couple the first clamp portion 126 to the second clamp portion 128.

The recesses 132 each have a radius such that the clamp terminator channel 133 has an inner diameter (i.e., the summed radii) as indicated at 136 in FIG. 5. The inner diameter 136 is slightly undersized relative to the uncompressed outer diameter 114 of the first end 104 of the cable 100. As the first clamp portion 126 and the second clamp portion 128 are fit tightly against one another, the buffer 112 is clamped between the first and second clamp portions 126, 128. The clamping action prevents the cable 100 from being inadvertently detached from the clamp terminator 108. In one embodiment, the diameter 136 of the channel 133 is approximately equal to the diameter of the strand bundle plus double the thickness of the buffer 112.

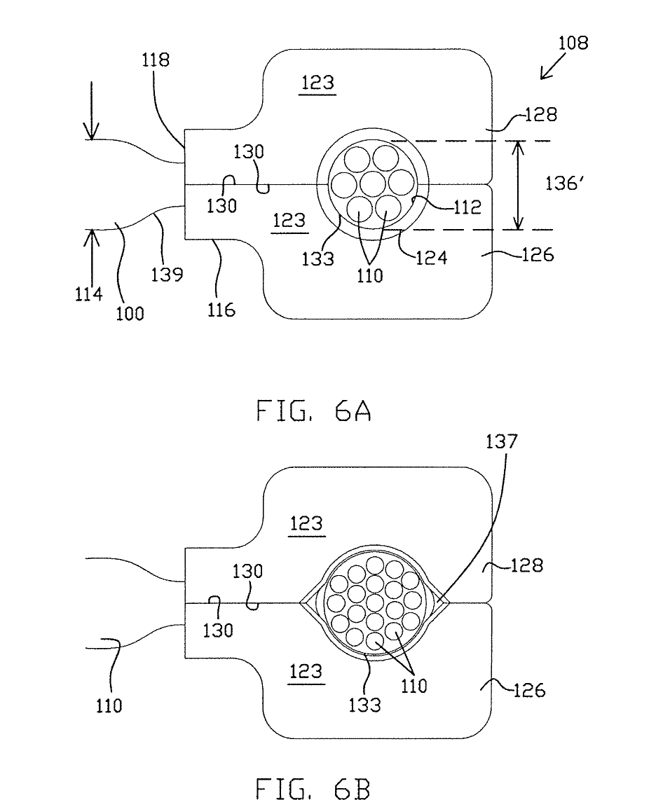

The clamping action also compresses the fiber cable 100 within the channel 133 to the inner diameter 136 of the channel 133. As the fiber cable 100 is compressed, the strands 110 are pressed against one another to remove or reduce the size of voids or spaces between the strands 110 and voids or spaces between the buffer 112 and the strands 110 (see FIG. 6A). Immediately adjacent the inlet 118, the fiber cable 100 forms a neck-down region 139 of decreasing diameter. The neck-down region 139 bridges the uncompressed portion of the cable 100 at diameter 114 to the compressed portion of the cable 100 within the clamp terminator 108 that has a reduced diameter 136′ that is approximately equal to the channel diameter 136.

The compressed portion of the cable 100 within the clamp terminator 108 is more rigid than the uncompressed portion of the cable 100 outside of the clamp terminator 108. The rigidity of the neck-down portion 139 increases closer to the clamp terminator 108.

FIG. 6B illustrates another embodiment of the clamp terminator 108 that further includes a buffer relief 137. The buffer relief 137 is a portion of the recess 132 provided to accommodate the buffer 112 and to prevent pinching of the buffer 112.

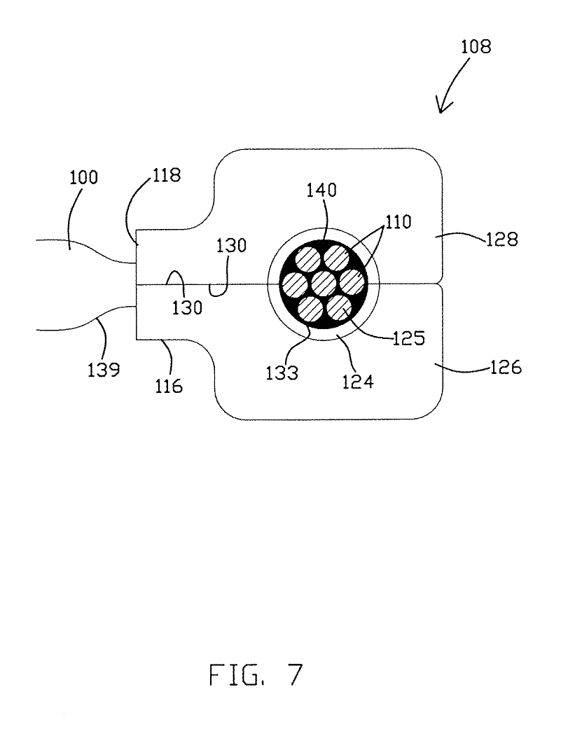

After the clamp terminator 108 has been clamped onto the end 104 of the fiber cable 100, any excess portion of the fiber cable 100 protruding beyond the clamp terminator outlet 122 is trimmed. An adhesive or other suitable bonding agent 140 is then dispensed onto the ends of the strands 110 at the clamp terminator outlet 122 (see FIG. 7). The bonding agent 140 can wick or be forced into any voids or spaces remaining between the strands 110 through capillary action. The bonding agent 140 is then allowed to cure. Curing can take place in the ambient atmosphere, or in a curing oven. After the bonding agent 140 has cured, the ends of the strands 110 and the bonding agent 140 at the clamp terminator outlet 122 are polished to form the end surface 125. The polished end surface 125 can be sufficiently flat and uniform to promote efficient transfer of optical signals therethrough for connectability.

In some embodiments, the channel 133 has cross sectional shapes other than circular. For example, the channel 133 can have an oval, elliptical, rectangular, triangular or other polygonal cross sectional shape, with the recesses 132 having corresponding cross-sectional shapes to cooperatively form the channel 133. In some embodiments, the recess 132 of the first clamp portion 126 has a different shape than the recess 132 of the second clamp portion 128 to form a non-circular channel 133.

Each recess 132 has a cross-sectional area that, together with the opposing recess 132, provides the channel 133 with a cross-sectional area over the shape of the channel 133. In general, the cross-sectional area of the channel 133 is the total area encompassed by the channel 133 in a plane perpendicular to the longitudinal axis of the cable 100. Thus, the cross-sectional area of the channel 133 is taken along the same plane as the cross-sectional area of the cable 100. The cross-sectional area of the channel 133 can be less than the cross-sectional area of the fiber cable 100 so that the cross-sectional area of the fiber cable 100 is reduced to the cross-sectional area of the channel 133 due to the clamping action of the clamp terminator 108. This is generally the same mechanism as is described above with respect to reducing the diameter of the cable 114 to the diameter 136 of the channel 133 under a clamping action.

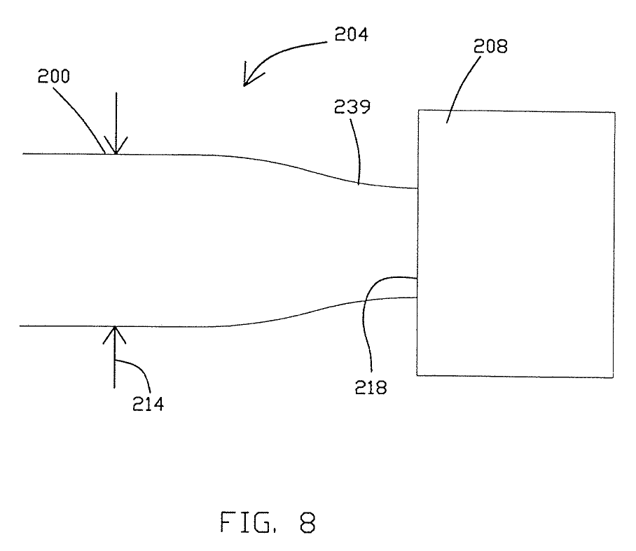

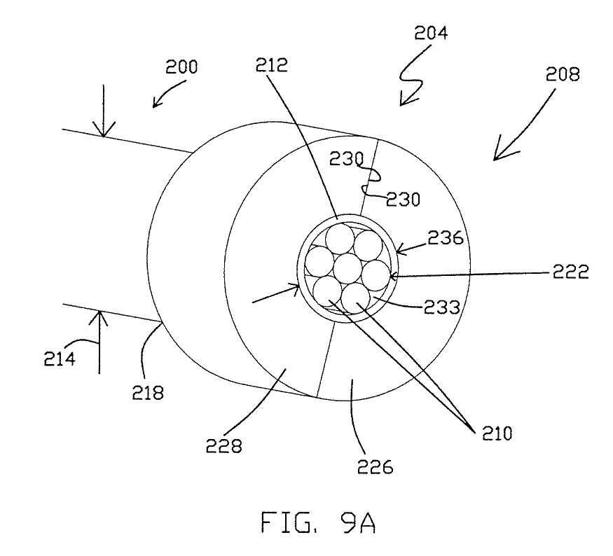

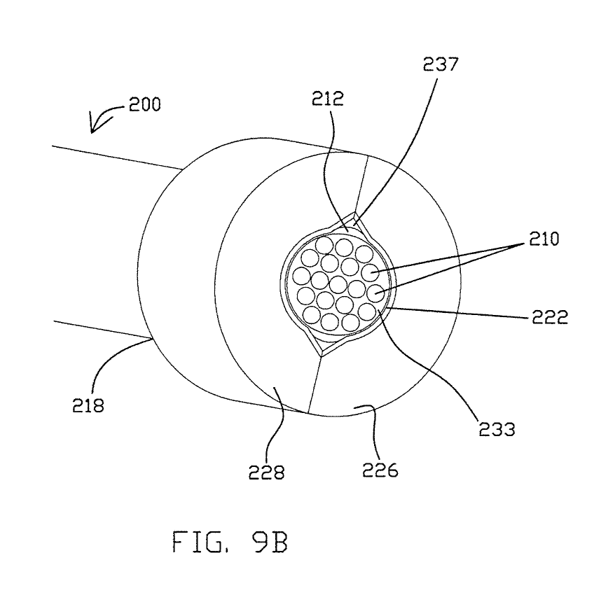

FIGS. 8-11 illustrate a fiber cable 200 according to another embodiment of the invention. The fiber cable 200 has a first end 204 and a second end (not shown), and a clamp terminator 208 coupled to the first end 204. Referring now to FIG. 9A, the fiber cable 200 is formed of a bundle of loosely arranged fiber optic strands 210, each capable of transmitting optical signals the length of the cable 200. A protective buffer or sheath 212 loosely encases the strands 210. The buffer 212 inhibits strand breakage and can also reduce crosstalk or signal contamination during use. The buffer 212 has an uncompressed outer diameter as indicated at 214.

The clamp terminator 208 is cylindrical or disc-shaped and includes an inlet 218 and an outlet 222. The clamp terminator 208 includes a first clamp portion 226 and a second clamp portion 228 coupled to one another. In the embodiment illustrated in FIGS. 8-11, the first clamp portion 226 and the second clamp portion 228 are mirror images of one another and also have the same configuration so that they are interchangeable.

FIG. 9B illustrates another embodiment of the clamp terminator 208 that further includes a buffer relief 237. The buffer relief 237 is a portion of the recesses 232 provided to accommodate the buffer 212 and to prevent pinching of the buffer 212.

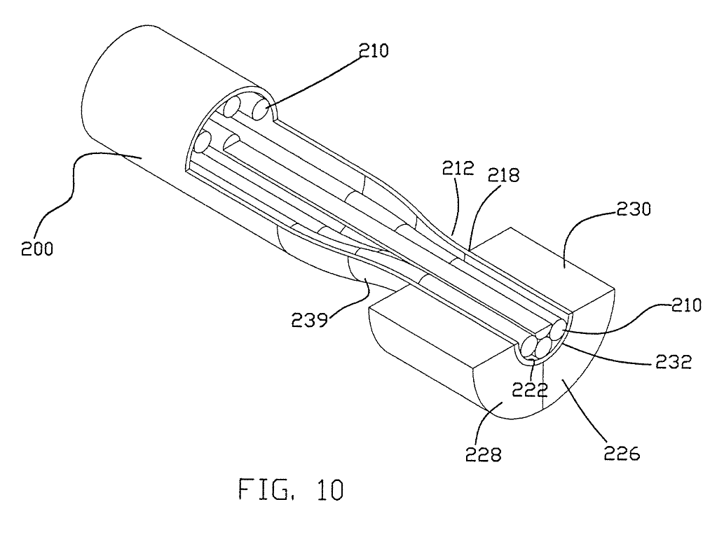

FIG. 10 illustrates the first clamp portion 226. As the second clamp portion 228 is structurally a mirror image of the first clamp portion 226, a description of the features of the first clamp portion 226 will suffice for a description of the features of the second clamp portion 228. The first clamp portion 126 has an inner engaging surface 230. The engaging surface 230 of the first clamp portion 226 faces the corresponding engaging surface of the second clamp portion 228. The engaging surface is clamped against the engaging surface of the second clamp portion 228 when the clamp terminator 208 is assembled (see FIG. 9).

Various recesses and/or bores extend inwardly from the engaging surface 230. When the first clamp portion 226 is assembled with the second clamp portion 228, the recesses of the first clamp portion 226 are opposite to and aligned with the recesses of the second clamp portion 228 to form voids within the clamp terminator 208. In the embodiment illustrated in FIGS. 8-11, the first clamp portion 226 includes an elongated recess 232 extending from the inlet 218 to the outlet 222. The recess 232 has a semi-circular cross sectional shape. When the clamp terminator 208 is assembled, the opposing recesses 232 form a channel 233 within the clamp terminator 208 having a circular cross sectional shape (see FIG. 9). The channel 233 formed by the opposing recesses 232 receive the fiber cable 200. In the illustrated embodiment, each recess 232 has an are of about 0 degrees (i.e., non-curvilinear).

The recesses 232 each have a radius such that the clamp terminator channel 233 has an inner diameter (i.e., the summed radii) as indicated at 236 in FIG. 9. The inner diameter 236 is slightly undersized relative to the uncompressed outer diameter 214 of the first end 204 of the cable 200. As the first clamp portion 226 and the second clamp portion 228 are fit tightly against one another, the cable 200 is clamped between the first and second clamp portions 226, 228. The clamping action prevents the cable 200 from being inadvertently detached from the clamp terminator 208.

The clamping action compresses the fiber cable 200 within the channel 233 to the inner diameter 236 of the channel 233. As the fiber cable 200 is compressed, the strands 210 are pressed against one another to remove or reduce voids or spaces between the strands 210. Immediately adjacent the inlet 218, the fiber cable 200 forms a neck-down region 239 of decreasing diameter. The neck-down region 239 bridges the uncompressed portion of the cable 200 to the compressed portion of the cable 200 within the clamp terminator 208. The compressed portion of the cable 200 within the clamp terminator 208 is more rigid than the uncompressed portion of the cable 200 outside of the clamp terminator 208. The rigidity of the neck-down portion 239 increases closer to the clamp terminator 208.

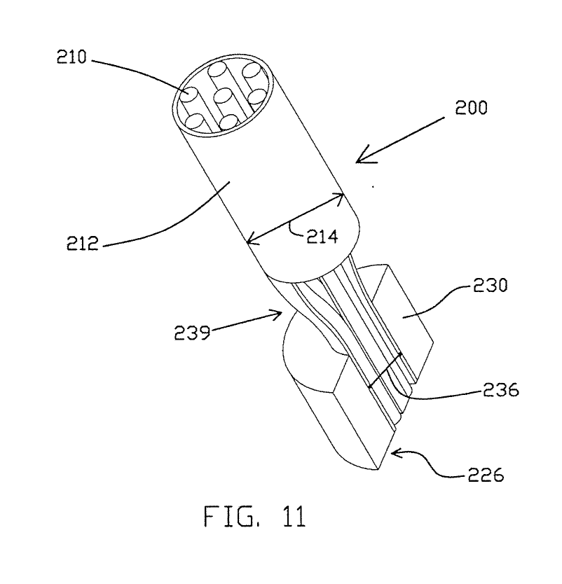

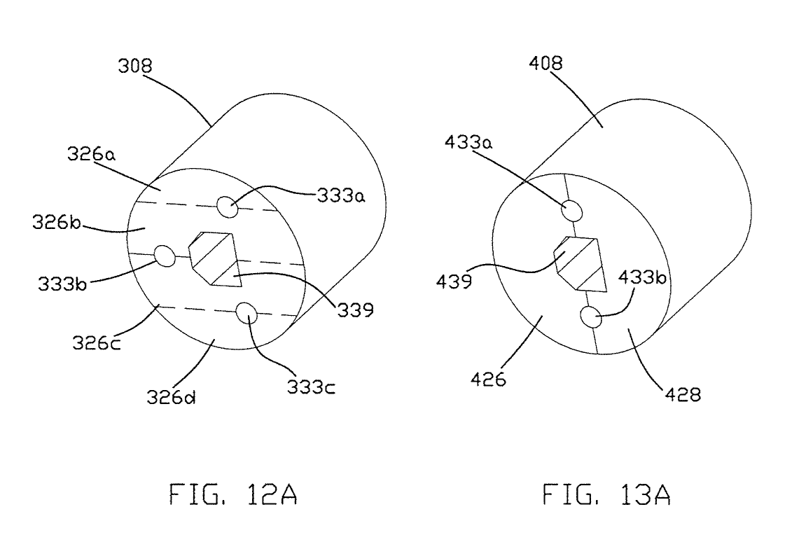

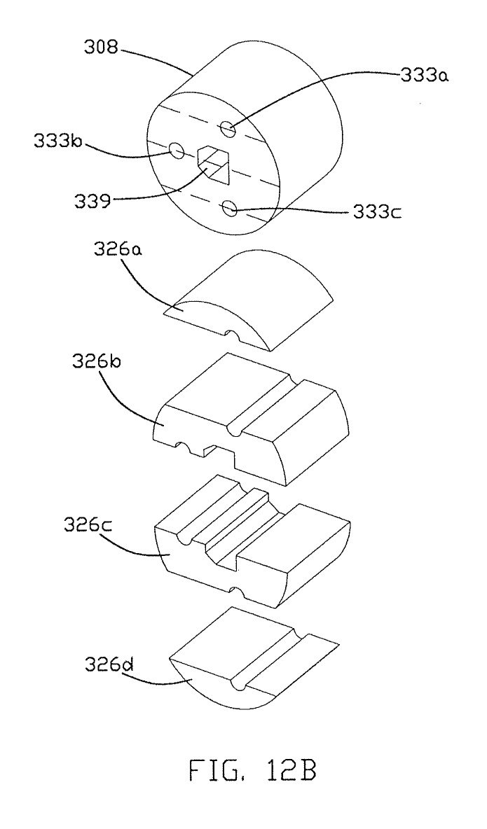

FIGS. 12A and 12B illustrate a clamp terminator 308 according to another embodiment of the invention. The clamp terminator 308 is formed of sequentially stacked first, second, third and fourth clamp portions 326a, 326b, 326c, and 326d. The first clamp portion 326a and the second clamp portion 326b include cooperating recesses forming a first fiber channel 333a. The second clamp portion 326b and the third clamp portion 326c include cooperating recesses forming a second fiber channel 333b. The third clamp portion 326c and the fourth clamp portion 326d include cooperating recesses forming a third fiber channel 333c. Thus, the clamp terminator 308 is capable of clamping and routing a plurality of fiber cables separately from one another.

The second clamp portion 326a and the third clamp portion 326c further define a secondary channel 339 therebetween when assembled. The secondary channel 339 can have a different cross-sectional shape and/or area than the channels 333a and 333b. The secondary channel 339 can receive another fiber cable therein. Alternately, a different type of cable or member can be received in or clamped within the channel 339.

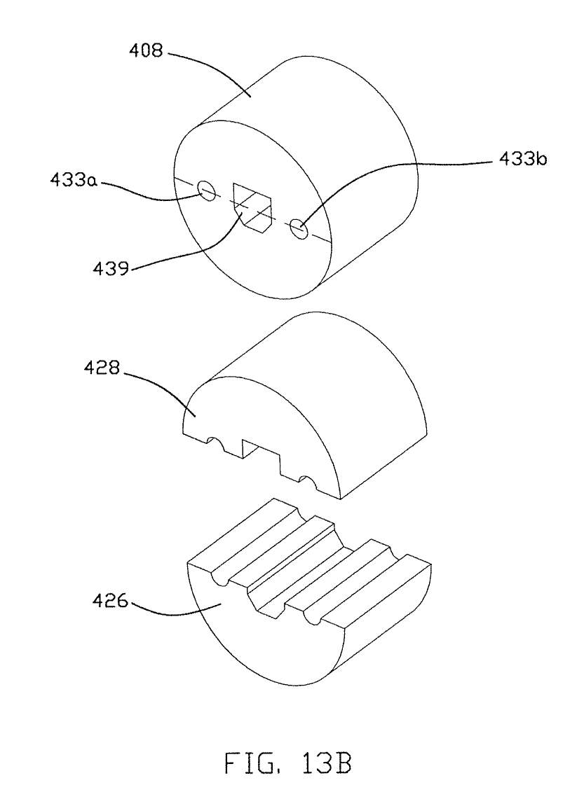

FIGS. 13A and 13B illustrate a clamp terminator 408 according to another embodiment of the invention. The clamp terminator 408 includes a first clamp portion 426 and a second clamp portion 428. The first and second clamp portions 426, 428 include cooperating recess forming a first fiber channel 433a and a second fiber channel 433b. The first clamp portion 426 and the second clamp portion 428 further define a secondary channel 439 therebetween when assembled. The secondary channel 439 can have a different cross-sectional shape and/or area than the channels 433a and 433b. The secondary channel 439 can receive another fiber cable therein. Alternately, a different type of cable or member can be received in or clamped within the channel 439.

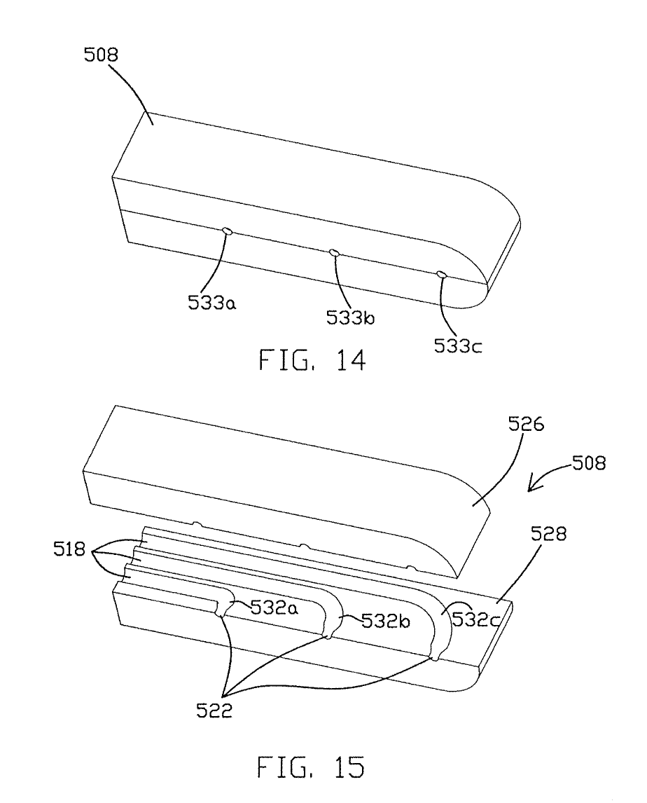

FIGS. 14 and 15 illustrate a clamp terminator 508 according to another embodiment of the invention. The clamp terminator 508 has an elongated shape and is formed of a first clamp portion 526 and a second clamp portion 528. The first and second clamp portions 526, 528 include cooperating recesses forming three channels 533a, 533b and 533c for receiving three fiber cables (not shown). Inlets 518 to the clamp terminator 508 are aligned with one another. Outlets 522 of the clamp terminator 508, however, are axially displaced from another so as to be spaced apart from one another. Thus, the recess 532a has a sharper are than the recess 532b, which has a sharper are than the recess 532c.

As also illustrated in FIGS. 14 and 15, the recesses 532a, 532b and 532c can have a variable diameter or cross-sectional area. For example, the recess 532a can have a first or inlet cross-sectional area adjacent to the inlet 518 and a second or outlet cross-sectional area adjacent to the outlet 522. Likewise, the channel 533a formed by the cooperating recesses 532a can have a first or inlet diameter or cross-sectional area adjacent to the inlet 518 and a second or outlet diameter adjacent to the outlet 522. The inlet cross-sectional area can be greater than the outlet cross-sectional area.

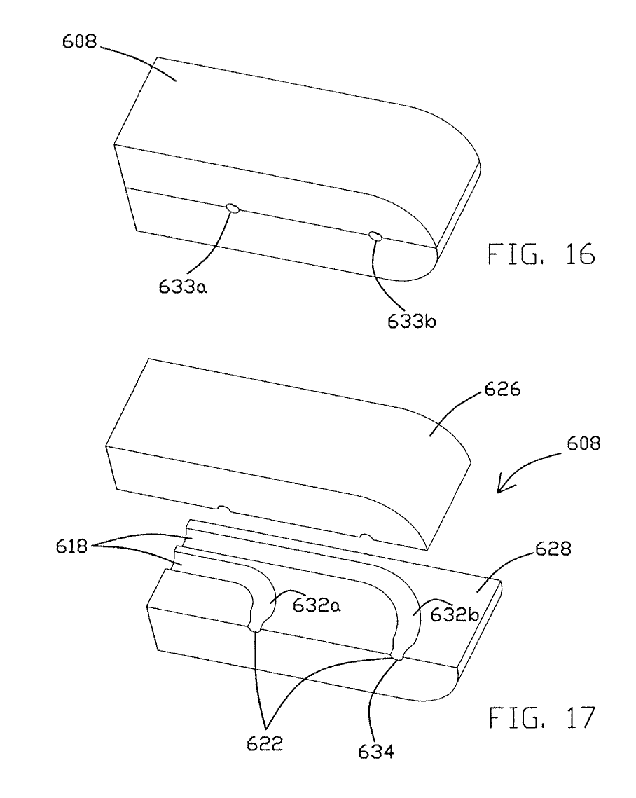

FIGS. 16 and 17 illustrate a clamp terminator 608 according to another embodiment of the invention. The clamp terminator 608 has an elongated shape and is formed of a first clamp portion 626 and a second clamp portion 628. The first and second clamp portions 626, 628 include cooperating recesses forming two channels 633a and 633b for receiving two fiber cables (not shown). Inlets 618 to the clamp terminator 608 are aligned with one another. Outlets 622 of the clamp terminator 608, however, are axially displaced from another so as to be spaced apart from one another. Thus, the recess 632a has a sharper are than the recess 632b.

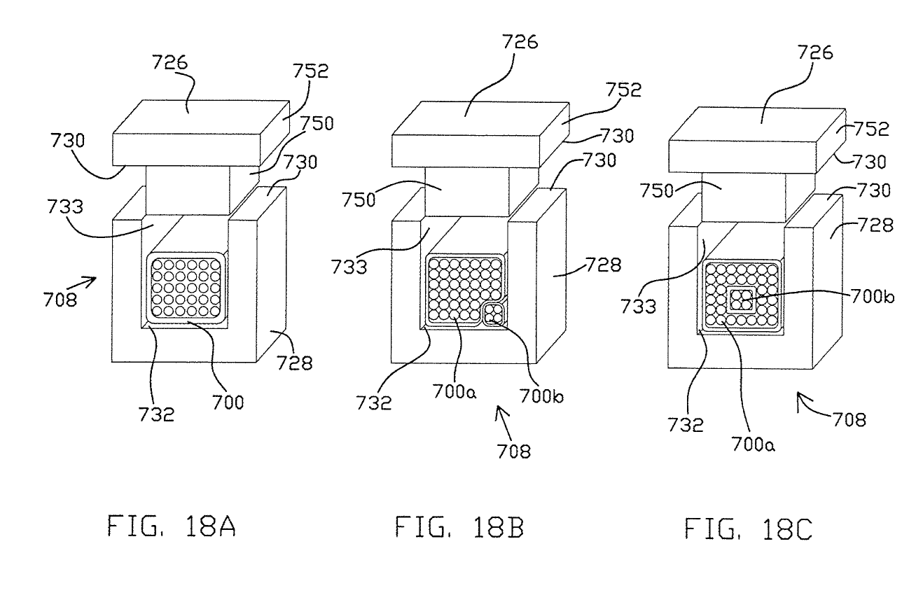

FIG. 18A illustrates a clamp terminator 708 according to another embodiment of the invention. The clamp terminator 708 differs from the embodiments previously described herein in that the channel 733 is not formed by cooperating recesses, but rather by a clamp protrusion 750 provided on the first clamp portion 726 and a cooperating recess 732 provided on the second clamp portion 728. The first clamp portion 726 further includes a stop flange 752 positioned about the clamp protrusion 750. An engaging surface 730 of the stop flange 752 contacts an engaging surface 730 of the second clamp portion 728 so that the clamp protrusion 750 extends into the recess 732. The clamp recess 732 and the seated protrusion 750 define a channel 733 therebetween for receiving the cable 700. In the illustrated embodiment, the first and second clamp portions 726, 728 have different shapes and configurations. Furthermore, as previously mentioned, the channel 733 has a rectangular (i.e., non-circular) cross-sectional shape, as does the cable 700.

FIG. 18B illustrates the clamp terminator 708 in relation to a first cable 700a and a second cable 700b. The clamp terminator 708 is capable of clamping both cables 700a and 700b within the channel. In this embodiment, the second cable 700b is smaller than the first cable 700a and is located in a corner of the channel 733. Furthermore, the second cable 700b is separate from the first cable 700a. FIG. 18C illustrates another embodiment, in which the second cable 700b is located within the first cable 700a. Again, the clamp terminator 708 is capable of clamping both cables 700a and 700b.

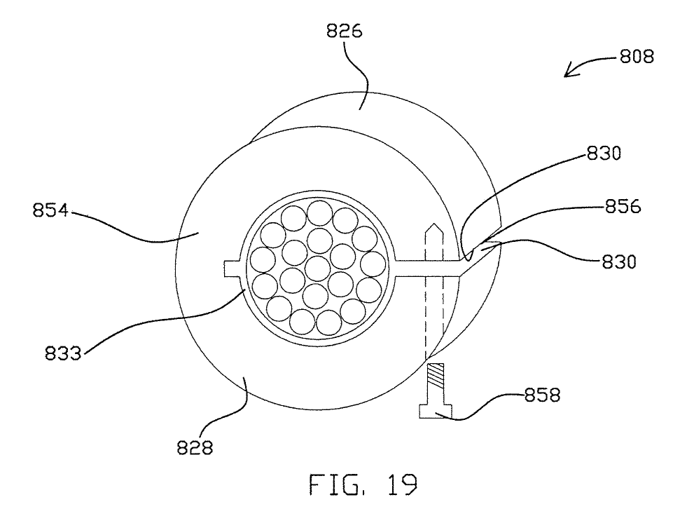

FIG. 19 illustrates a clamp terminator 808 according to another embodiment of the present invention. In the illustrated embodiment, the clamp terminator 808 is approximately C-shaped. The clamp terminator 808 includes a first clamp portion 826 and a second clamp portion 828 that are integrally joined with one another at a bridge portion 854 and spaced apart from one another opposite the bridge portion 854 to form a gap 856. The clamp terminator 808 includes a channel 833 between the first clamp portion 826 and the second clamp portion 828. The channel 833 has a first cross-sectional area when the gap 856 is open, as illustrated in FIG. 19. A second, reduced cross-sectional area is formed when the engaging surfaces 830 of the first and second clamp portions 826, 828 are contacted to close the gap 856. A fastener 858 is provided for securing the first clamp portion 826 to the second clamp portion 828 to close the gap 856.

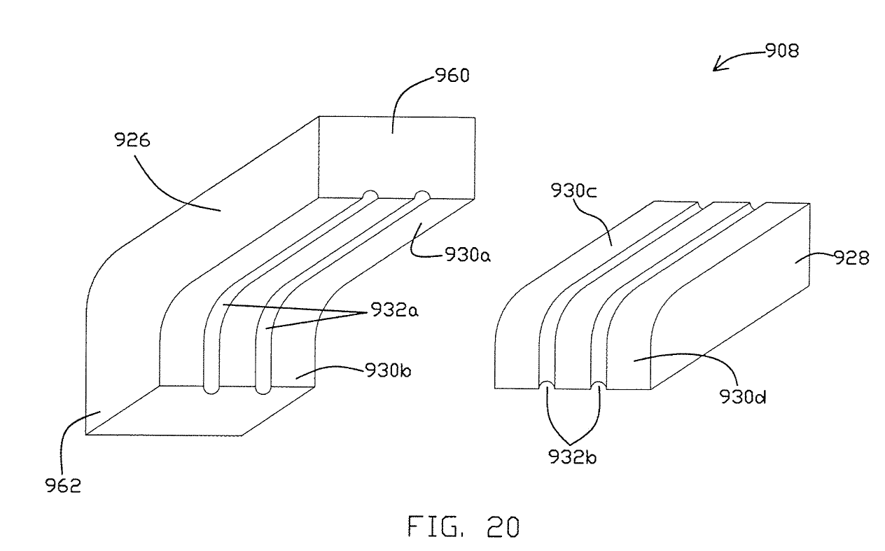

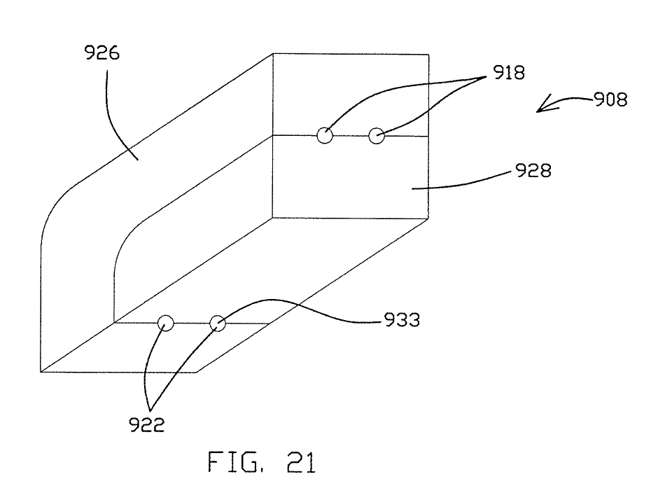

FIGS. 20 and 21 illustrate a clamp terminator 908 according to another embodiment of the invention. The first clamp portion 926 is approximately L-shaped and includes a first leg 960 and a second leg 962. The second clamp portion 928 is sized and shaped to be received in the first clamp portion 926. When assembled, as illustrated in FIG. 21, the first and second clamp portions 926, 928 cooperate to form an approximately rectangular bar shaped clamp terminator 908.

The first clamp portion 926 includes engaging surface 930a and 930b on the first leg 960 and second leg 962, respectively. A pair of recesses 932a extend along the engaging surfaces 930a and 930b. The second clamp portion 928 includes engaging surface 930c and 930d at the top and side. Likewise, a pair of recesses 932b extend along the engaging surfaces 930c and 930d. When the clamp terminator 908 is assembled, as illustrated in FIG. 21, the recesses 932a and 932b cooperate to form channels 933 in which the inlet 918 is formed on an end of the clamp terminator 908 and the outlet 922 is formed on a lower surface of the clamp terminator 908.

Thus, the invention provides, among other things, a clamp terminator for a fiber bundle. Various features and advantages of the invention are set forth in the following claims.

What is claimed is:

1. A fiber cable assembly comprising:
a cable including a bundle of fiber optic strands and a buffer encasing the bundle, the cable having a longitudinal axis and a first cross-sectional area in a plane perpendicular to the longitudinal axis; and
a terminator clamp coupled to an end of the cable over the buffer, the terminator clamp including:
a first clamp portion and a second clamp portion, the first and second clamp portions each having an engaging surface for engaging the other of the first clamp portion and the second clamp portion; and
aligned recesses extending inwardly from the engaging surface of the first clamp portion and the second clamp portion, the aligned recesses forming a channel within the terminator clamp for receiving the end of the cable, wherein the channel has a channel cross-sectional area in a plane perpendicular to the longitudinal axis of the cable, the channel cross-sectional area being less than the cable cross-sectional area;
wherein the cable is compressed within the channel to the channel cross-sectional area.

2. The fiber cable assembly of claim 1, wherein the first clamp portion is a mirror image of the second clamp portion.

3. The fiber cable assembly of claim 1, wherein the first clamp portion and the second clamp portion are connected at a bridge portion.

4. The fiber cable assembly of claim 1, wherein the strands less closely spaced within the buffer outside of the clamp terminator and are more closely spaced within the buffer inside of the clamp terminator.

5. The fiber cable assembly of claim 1, wherein the cable forms a neck-down region of decreasing cross-sectional area immediately adjacent the terminator clamp.

6. The fiber cable assembly of claim 1, further comprising a bonding agent within spaces between strands of the cable adjacent to the terminator clamp.

7. The fiber cable assembly of claim 1, further comprising a plurality of cables, wherein the terminator clamp includes a plurality of channels for receiving each cable separately.

8. The fiber cable assembly of claim 1, wherein the channel has a first cross-sectional area adjacent to the inlet and a second cross-sectional area adjacent to the outlet, the second cross-sectional area being less than the first cross-sectional area.

9. The fiber cable assembly of claim 1, wherein the channel is arced within the terminator clamp at an angle of from about 0 degrees to about 90 degrees.

10. The fiber cable assembly of claim 1, further comprising a buffer relief feature in the first clamp portion.

11. A terminator clamp for coupling to an end of a fiber cable, the terminator clamp comprising:
a first clamp portion and a second clamp portion, the first and second clamp portions each having an engaging surface for engaging the other of the first clamp portion and the second clamp portion; and
a channel formed between the first clamp portion and the second clamp portion, the channel having a cross-sectional area that is less than the cross-sectional area of the fiber cable.

12. The clamp terminator of claim 10, wherein the first clamp portion and the second clamp portion are connected at a bridge portion.

13. The terminator clamp of claim 10, wherein the first clamp portion is a minor image of the second clamp portion.

14. The terminator clamp of claim 10, wherein the first clamp portion includes a protrusion and the second clamp portion includes a recess for receiving the protrusion, the channel being formed between the protrusion and the recess.

15. The clamp terminator of claim 10, wherein the channel has a first cross-sectional area adjacent to an inlet and a second cross-sectional area adjacent to an outlet, the second cross-sectional area being less than the first cross-sectional area.

16. The terminator clamp of claim 10, wherein the terminator clamp includes a plurality of channels for receiving a plurality of fiber cables separately.

17. A method of manufacturing a fiber cable of the type including a plurality of loosely bundled fiber optic strands encased in a buffer, the method comprising:
placing a portion of an end of the fiber cable into a recess in an engaging surface of a first clamp portion, the fiber cable having a first cross-sectional area in a plane perpendicular to a longitudinal axis of the fiber cable;
aligning a second clamp portion to the first clamp portion, the second clamp portion having a cooperating recess in an engaging surface for receiving a portion of the fiber cable;
contacting the engaging surface of the first clamp portion with the engaging surface of the second clamp portion to form a channel between the aligned recesses, the channel having a channel cross-sectional area that is less than the fiber cable cross-sectional area; and
compressing the fiber optic cable within the channel to a second cross-sectional area that is less than the first cross-sectional area.

18. The method of claim 16, further comprising trimming any portion of the fiber cable extending beyond an outlet of the terminator clamp approximately flush with a surface of the terminator clamp.

19. The method of claim 16, further comprising inserting an adhesive into the fiber cable at the terminator clamp.

20. The method of claim 16, further comprising polishing an end surface of the fiber cable flush with a surface of the terminator clamp.
